(19) United States
(12) Patent Application Publication
(10) Pub. No.: US 2024/0367114 A1
(43) Pub. Date: Nov. 7, 2024

(54) MEMBRANE WITH REACTED NETWORKS

(71) Applicant: Celgard, LLC, Charlotte, NC (US)

(72) Inventors: Wenbin Yin, Charlotte, NC (US); Stefan Reinatz, Waxhaw, NC (US)

(21) Appl. No.: 18/287,035

(22) PCT Filed: Apr. 28, 2022
(86) PCT No.: PCT/US2022/026614

§ 371 Date: Oct. 16, 2023

Related U.S. Application Data
(60) Provisional application No. 63/182,526, filed on Apr. 30, 2021.

(51) Int. Cl. B01D 71/26; B01D 67/00; B01D 69/14; B01D 71/46

(52) U.S. Cl. CPC B01D 71/261; B01D 67/0013; B01D 67/0027; B01D 69/141; B01D 71/262; B01D 71/46; B01D 2323/081; B01D 2323/219; B01D 2323/46; B01D 2325/02

(57) ABSTRACT

Disclosed is a membrane with one or more dry-process porous layers that comprise (1) a polyolefin and (2) a product formed by reacting two components, which may be a compound with one or more carboxy groups and a compound with one or more epoxy groups. The product may be a reaction network, a three-dimensional reaction network, or a cross-linked network The resulting membrane has improved strength, reduced splittiness, or both improved strength and reduced splittiness. The membrane may be used in a battery, capacitor, HVAC, filtering device, or textile. Methods for making the membrane are also disclosed.

### RELATED APPLICATIONS

This application is a 371 application to PCT Application No. PCT/US2022/026614, filed Apr. 28, 2022, which claims priority to U.S. Provisional Application No. 63/182,526, filed Apr. 30, 2021, which are incorporated herein by reference in their entireties.

### FIELD

This application is directed to the field of membranes having at least improved strength, reduced splittiness, or a combination of these properties. The membranes may be used as battery separators, particularly battery separators for secondary batteries, including lithium ion batteries. They may also be used in capacitors, as textiles, as filters, and the like. This application is also directed to method for forming these improved membranes.

### BACKGROUND

There are many advantages to dry-process film, but one drawback is that some dry-process films are “splitty” or have a “splittiness” issue. As understood by those in the art, “splittiness” refers to the tendency of a film to form splits or tears that may be inches in length or more. This is undesirable, for example, if the film is used in battery or textile applications. In battery applications, the splits or tears may cause a safety issue, allowing long openings that dendrites can grow through. In textile applications, a split or tear compromises the barrier function of the textile, allowing moisture, air, and the like to penetrate. In filtration applications, splits or tears may allow particles through that the filter was supposed to block.

In view of the foregoing, reducing the length of splits or tears, or eliminating them completely, is desirable.

### SUMMARY

The present invention provides at least a membrane having improved strength, reduced splittiness, or a combination of the two, and also provided is a method for making the same.

In one aspect, a membrane comprising at least one dry-process porous layer is disclosed. The dry-process porous layer may comprise the following: a polyolefin and a product formed by reacting a compound with one or more carboxy groups and a compound with one or more epoxy groups. The membrane may be a monolayer, bilayer, trilayer, or multilayer membrane wherein the dry-process porous layer is at least one of the layers.

The compound with one or more epoxy groups may have from 1 to 10 or 1 to 5 epoxy groups. In some embodiments, the compound having one or more epoxy groups is a polyethylene oxide (PEO) or a polyethylene glycol (PEG) having two or more epoxy groups.

The compound with one or more carboxy groups may have from 1 to 10 or 1 to 5 carboxy groups.

The polyolefin, in some preferred embodiments, is a polyethylene polymer, a polyethylene copolymer, a polyethylene terpolymer, or a blend of a polyethylene polymer, copolymer, or terpolymer and another polymer. In other preferred embodiments, the polyolefin is a polypropylene polymer, a polypropylene copolymer, a polypropylene terpolymer, or a blend of a polypropylene polymer, copolymer, or terpolymer and another polymer.

In another aspect, a battery separator, a capacitor, a textile, a filter, or the like comprising a membrane as described hereinabove and an optional coating is described. The coating may be a ceramic coating, a polymer coating, an adhesive coating, a shutdown coating, or combinations thereof.

In another aspect, two separate dry-process porous layer formation methods are disclosed.

In a first method, there are at least three steps. The first step is extruding or casting a composition comprising a polyolefin, a compound having one or more epoxy groups, and a compound having one or more carboxy groups to form a non-porous precursor. In another step, the non-porous precursor is stretched to form pores. Yet another step involves applying at least enough heat to cause the compound having one or more epoxy groups to react with the compound having one or more carboxy groups. Heat may be applied before stretching, after stretching, during stretching, or in any combination of the foregoing. For example, heat may be applied before and during stretching, before and after stretching, during and after stretching, or before, during, and after stretching.

In the second method, a solution that comprises a compound having one or more carboxy groups, a compound having one or more epoxy groups, and a solvent is applied to a dry-process porous polyolefin film to form an impregnated dry-process porous polyolefin film. Then, heat is applied in an amount sufficient to cause the compound having one or more epoxy groups to react with the compound having one or more carboxy groups.

In this second method, the solvent may be water, an organic solvent, or a combination of water and an organic solvent.

In some embodiments, a surfactant may be added to the solution.

In some preferred embodiments of this second method, the dry-process porous polyolefin film comprises a polyethylene polymer, a polyethylene copolymer, a polyethylene terpolymer, or a blend of a polyethylene polymer, copolymer, or terpolymer and another polymer. In other preferred embodiments, the dry-process porous polyolefin film comprises a polypropylene polymer, a polypropylene copolymer, a polypropylene terpolymer, or a blend of a polypropylene polymer, copolymer, or terpolymer and another polymer.

### DESCRIPTION OF FIGURES

FIG. 1 shows a reaction of an epoxy group and a carboxy group according to some embodiments described herein.

FIG. 2 includes examples of surfactants with reactive groups as described herein.

FIG. 3 shows a reaction according to some embodiments described herein.

FIG. 4 shows a reaction according to some embodiments described herein.

FIG. 5 is schematic view of a membrane with reacted networks as described herein.

### DETAILED DESCRIPTION

### Membrane

In one aspect, a membrane comprising, consisting of, or consisting essentially of a dry-process porous layer is described. The membrane may be a monolayer membrane, a bilayer membrane, a trilayer membrane or a multilayer (four or more layers) membrane where the dry-process porous layer is at least one layer of the membrane. For bilayer, trilayer, and multilayer membranes, these may be formed by laminating at least one dry-process porous layer with at least one other layer or by co-extruding at least one dry process porous layer as claimed with another layer. In some embodiments, the trilayer and multilayer membranes may be formed by a combination of co-extrusion and lamination. For example, a dry-process porous layer as claimed may be laminated to two or more other layers that were co-extruded. Alternatively, a dry-process porous layer as claimed may be co-extruded with one or more other layers, and then the co-extruded layers may be laminated to another layer.

The membrane may have a thickness from 1 to 100 microns, 1 to 50 microns, 1 to 40 microns, 1 to 30 microns, 1 to 20 microns, 1 to 15 microns, 1 to 10 microns, or 1 to 5 microns.

As understood by those skilled in the art, a “dry-process” is one that does not involve the use of solvents or oils, particularly during a casting or extrusion step, form a porous film, layer, or membrane. A typical dry process may involve at least the steps of extruding or casting a composition to form a non-porous precursor film or layer, and stretching the non-porous precursor film or layer to form pores. A dry process may or may not use particles to form or aid in the formation or pores. Further, it is known by those skilled in the art that dry-process membrane have a distinct structure when compared with a “wet process,” which utilizes solvents and/or oils in a casting or extrusion step. See, for example, P. Arora and Z. Zhang, Battery Separators, Chem. Rev. 104, 4419-4462.

The dry-process porous layer described herein may be nanoporous, microporous, mesoporous, or macroporous. In some preferred embodiments, the dry-process porous layer may be microporous or may have an average pore size from 0.01 to 1.0 microns.

The layer may have a thickness from 1 to 100 microns, 1 to 50 microns, 1 to 40 microns, 1 to 30 microns, 1 to 20 microns, 1 to 15 microns, 1 to 10 microns, or 1 to 5 microns.

The dry-process porous layer described herein may comprise, consist of, or consist essentially of at least the following components: (1) a thermoplastic polymer, e.g., a polyolefin and (2) a product formed by reaction, e.g. a reaction product formed by reacting a least one compound having one or more epoxy groups and a compound having at least one carboxy group. In some embodiments, the product may be a reaction network, a three-dimensional reaction network, or a three-dimensional cross-linked network, where the reaction is a cross-linking reaction.

### (1) Thermoplastic Polymer

Any thermoplastic polymer may be used, but in preferred embodiments, the thermoplastic polymer may be a polyolefin. For example, the thermoplastic polymer may be a polyethylene homopolymer, a polyethylene copolymer, a polyethylene terpolymer, or a blend of a polyethylene homopolymer, a polyethylene copolymer, or a polyethylene terpolymer and at least one additional thermoplastic polymer. The blend may include a polyethylene homopolymer and a polyethylene copolymer, for example. The thermoplastic polymer may also be a polypropylene homopolymer, a polypropylene copolymer, a polypropylene terpolymer, or a blend of a polypropylene homopolymer, a polypropylene copolymer, or a polypropylene terpolymer and at least one additional thermoplastic polymer. The blend may include a polypropylene homopolymer and a polypropylene copolymer, for example.

### (2) Product Formed by Reaction

The product formed by reaction is formed by reacting a compound with one or more, two or more, three or more, four or more, five or more, six or more, seven or more, eight or more, nine or more, or ten or more reactive groups with at least one other compound that includes one or more reactive groups. The reactive groups of the compounds that are reacted are not limited. Any set of reactive groups that will react with each other is acceptable.

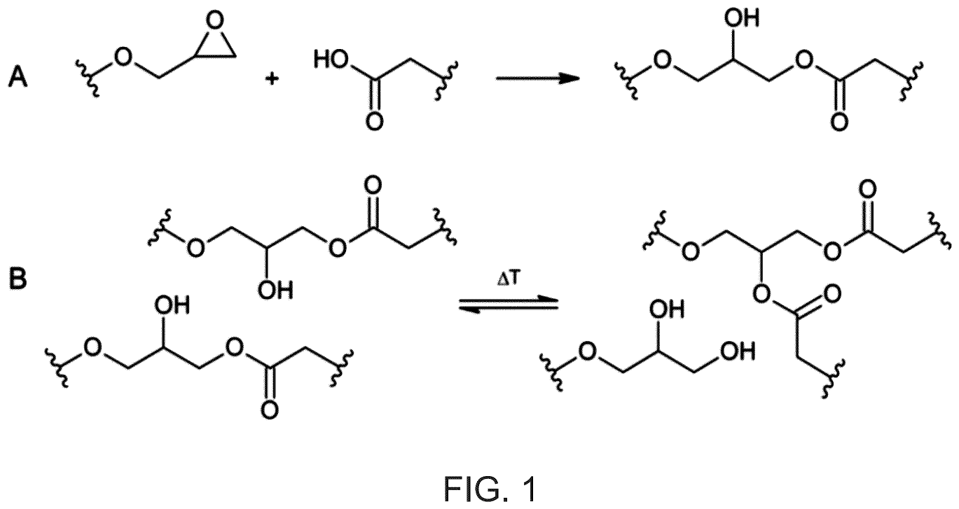

For example, in some preferred embodiments, a compound with one or more carboxy groups and a compound with one or more epoxy groups may be chosen. The epoxy group and the carboxy group will react with one another as shown in FIG. 1.

In some embodiments, the compound having one or more epoxy groups may have one, two, three, four, five, six, seven, eight, nine, or ten epoxy groups. In some preferred embodiments, the number of epoxy groups may be greater than ten, less than ten, or from one to five.

In some embodiments, the compound having one or more epoxy groups is a polyethylene oxide (PEO) or polyethylene glycol (PEG) compound with one or more epoxy groups. The PEO or PEG compound may be a bi-, tri-, tetra-, or poly-glycidyl ether. It may have a structure as shown in Formulae 1-6 below:

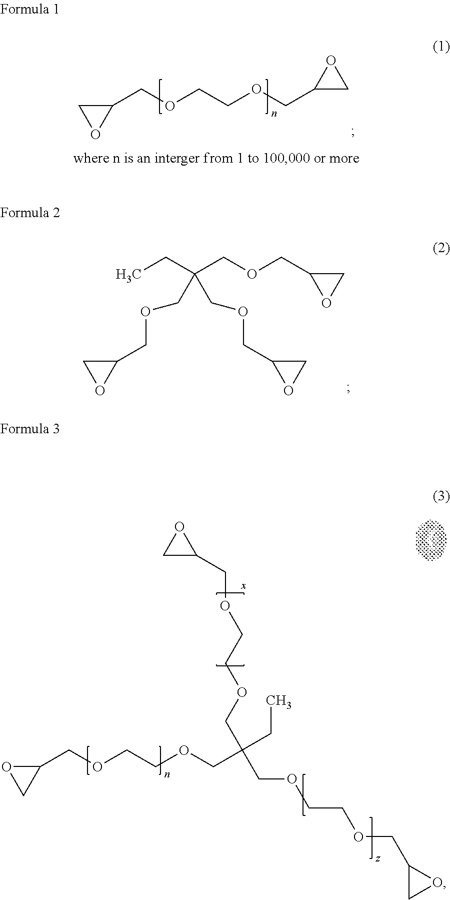

where x, y, and z may each independently be from 1 to 100,000 or more;

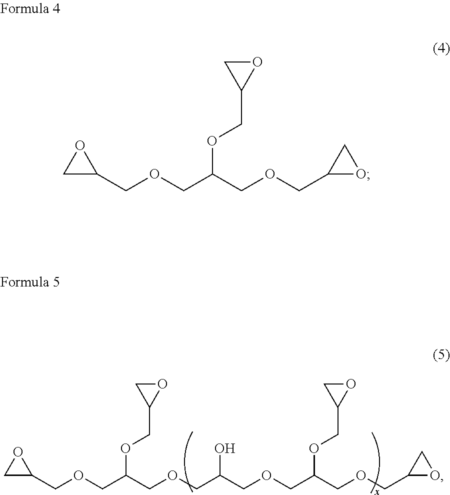

where x may be from 1 to 100,000 or more; or

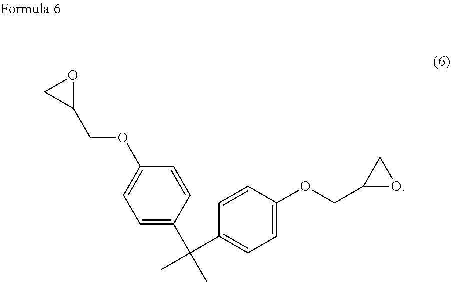 [SMILES: CC(C)(c1ccc(OCC2CO2)cc1)c1ccc(OCC2CO2)cc1]

The compound having one or more carboxy groups is also not so limited and the compound may have one, two, three, four, five, six, seven, eight, nine, or ten carboxy groups. In some preferred embodiments, the number of carboxy groups may be greater than ten, less than ten, or from one to five. Exemplary compounds may include keto acids, monocarboxyic acids, dicarboxylic acids, tricarboxylic acids, tetracarboxylic acids, penta carboxylic acids, hexacarboxylic acids, and the like.

In some preferred embodiments, at least one of the compound having one or more carboxy groups and the compound having one or more epoxy groups has two or more, or three or more reactive (carboxy or epoxy, respectively) groups. With more reactive groups more reactions can occur with a single molecule, resulting in a larger network capable of being formed. For example, if a tetracarboxylic acid is used, there are four reaction sites for reaction with the epoxy group of the compound containing one or more epoxy groups. How many sites are reacted may depend on the amount of heat applied.

Formation of these compounds, which are large or small networks of reacted components (reaction networks) with carboxy and epoxy groups, adds strength to the films and prevents splittiness or the size (length) of the splits formed. In preferred embodiments, the reaction network is a three-dimensional reaction network.

### Device

A device may comprise the membrane described herein. For example, the membrane may be used as a battery separator, to replace or improve the porous, typically cellulosic, film of a capacitor, as a textile, as a filter, or the like. A stronger and less splitty film would be beneficial in each of these applications. For example, in a textile, a film that does not split or tear is desirable. In a battery, a less splitty separator improves safety. Dendrites may cause splits in a splitty separator, causing a short. If the splits can be eliminated or reduced (e.g., smaller sized/length of splits) safety will be improved.

In some embodiments, the membrane may be used as a separator for a secondary battery such as a lithium ion battery. Any type of lithium ion battery may be appropriate, including those using NMC or LFP as electrode materials. The membrane may also be used in large format lithium ion batteries. A coating may optionally be applied to the membrane. The coating may be a single or multilayer (two or more layers) coating. The coating may be a ceramic coating, a sticky or adhesive coating, a shutdown coating, a cross-linked coating, or combinations of the foregoing.

### Method

### (1) First Method

The first method may comprise at least three steps to form a dry-process porous film or layer as described herein.

First, a composition comprising, consisting of, or consisting essentially of a thermoplastic polymer, and two compounds that may be reacted with each other are extruded or cast to form a non-porous precursor film. In a preferred embodiment, the composition may comprise, consist of, or consist essentially of a polyolefin, a compound comprising at least one epoxy group, and a compound comprising at least one carboxy group are extruded or cast to form a non-porous precursor film or layer. In preferred embodiments, the composition that is extruded or cast does not include a solvent or oil, and the process is a dry-process. In some embodiments, the composition described herein above may be co-extruded with at least one other identical or a different composition to form a co-extruded non-porous precursor film or layer.

An additive may also be added to the composition in some embodiments. For example, an initiator, which may aid in the initiation of the reaction between the compounds having carboxy and the compounds having epoxy groups.

Two additional steps of the first method include stretching the non-porous to form pores and applying heat to initiate a reaction between the carboxy group(s) and the epoxy group(s).

With regard to stretching, the non-porous precursor film or layer may be stretched uniaxially, biaxially, or along three or more axes to form and shape the pores. In a preferred embodiment, the non-porous precursor film may be stretched along the machine direction (MD) to form pores. In some other preferred embodiments, the non-porous precursor film or layer may be stretched along the MD and then along the transverse direction (TD) to round or shape the pores.

Heating is not so limited. The amount of heat applied must be sufficient to initiate and/or sustain the reaction of between the compound having one or more carboxy groups and the compound having one or more epoxy groups. However, the temperature cannot be so hot that it affects the structural integrity of the film.

Heat may be applied to the film before stretching, during stretching, after stretching, or any combination thereof. In some embodiments, it may be provided before and during stretching. In some embodiments, it may be provided before and after stretching. In some embodiments, it may be provided during and after stretching. In some embodiments, it may be provided before, during, and after stretching.

The dry-process porous film or layer formed may be used alone, laminated to another film or layer made by the same or a different method, coated, or combinations thereof.

### (2) Second Method

In a second method, the method may comprise at least two steps to form a dry process porous membrane as described herein.

In a first step, a solution comprising, consisting of, or consisting essentially of two compounds that may be reacted with each other and a solvent are applied to a dry-process porous membrane (pores already formed) comprising, consisting of, or consisting essentially of a thermoplastic polymer. The dry-process porous membrane comprising, consisting of, or consisting essentially of a thermoplastic polymer may also comprise the two compounds that may be reacted with one another, but in a preferred embodiment, it does not.

In a preferred embodiment, the solution may comprise, consist of, or consist essentially of a compound having one or more epoxy groups as described herein, a compound having one or more carboxy groups as described herein, and a solvent. In this preferred embodiment, the dry-process porous membrane on which the solution is applied does not contain a compound having one or more epoxy groups or a compound having one or more carboxy groups, but it may if desired. In this preferred embodiment, the dry-process porous membrane comprising, consisting of, or consisting essentially of a thermoplastic polymer, which the solution is applied on, may comprise, consist of, or consist essentially of a polyolefin, including any polyolefins described herein.

The solvent used in the solution is not so limited and may be water, an aqueous solvent including water and a solvent soluble in water, an organic solvent, or mixtures thereof.

Additives may be added to the solution. For example an initiator compound may be added, which will aid in initiation of the reaction between the compounds having one or more epoxy and one or more carboxy groups.

When the solution is applied to a dry-process porous film comprising, consisting of, or consisting essentially of a thermoplastic, which may be a polyolefin, the reactive components are allowed to penetrate into the pores of the film, impregnating the film. In some embodiments, a surfactant may be added to the solution to aid with this process. The result of the first step is an impregnated film comprising the reactive components within the pores of a dry-process porous film comprising, consisting of, or consisting essentially of a thermoplastic.

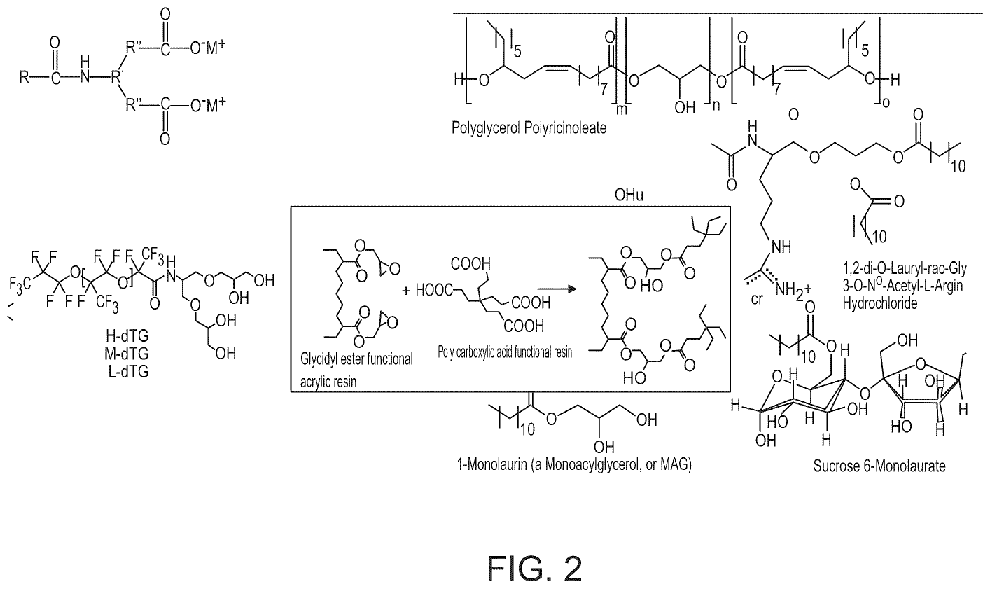

When a surfactant is added, in some embodiments, the surfactant may include one or more reactive groups. I some embodiments, the surfactant may comprise the compound with one or more epoxy groups, the compound with one or more carboxy groups, or both the compound with one or more epoxy groups or one or more carboxy groups. Examples of surfactants with reactive groups are provided in FIG. 2.

In another step, heat is applied to the impregnated dry-process porous film comprising, consisting of, or consisting essentially of a thermoplastic.

Heating is not so limited. The amount of heat applied must be sufficient to initiate and/or sustain the reaction of between the reactive compounds, e.g., the compound having one or more carboxy groups and the compound having one or more epoxy groups. However, the temperature cannot be so hot that it affects the structural integrity of the impregnated dry-process porous film comprising, consisting of, or consisting essentially of a thermoplastic.

### EXAMPLES

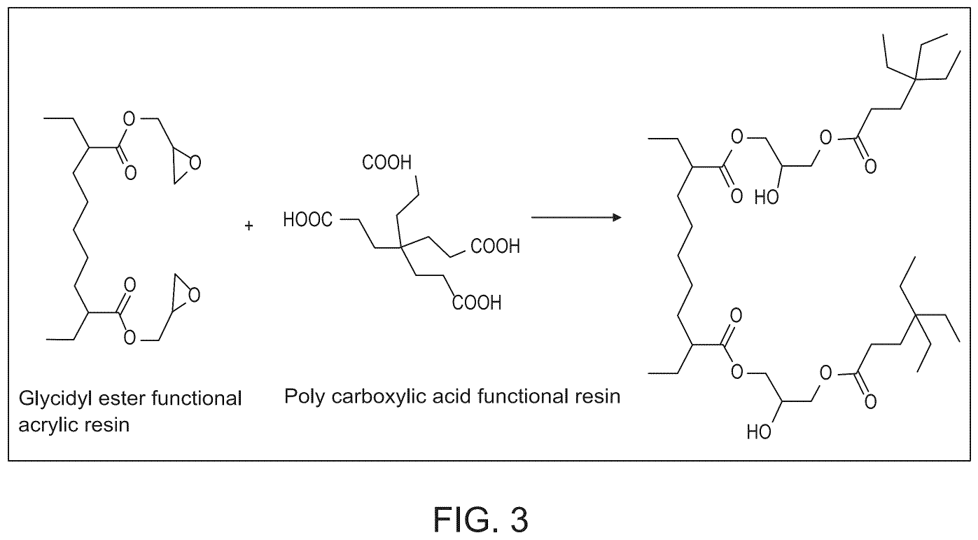

Example 1: In Example 1, a composition of polyethylene, a glycidyl ester functional resin, and a poly carboxylic acid functional resin is extruded to form a non-porous precursor, the non-porous precursor is stretched to form pores, and the glycidyl ester functional resin and the poly carboxylic acid functional resin are reacted as shown in the FIG. 3 to form the reacted product on the right.

Example 2: Example 2 is like Example 1 except that polypropylene is used instead of polyethylene.

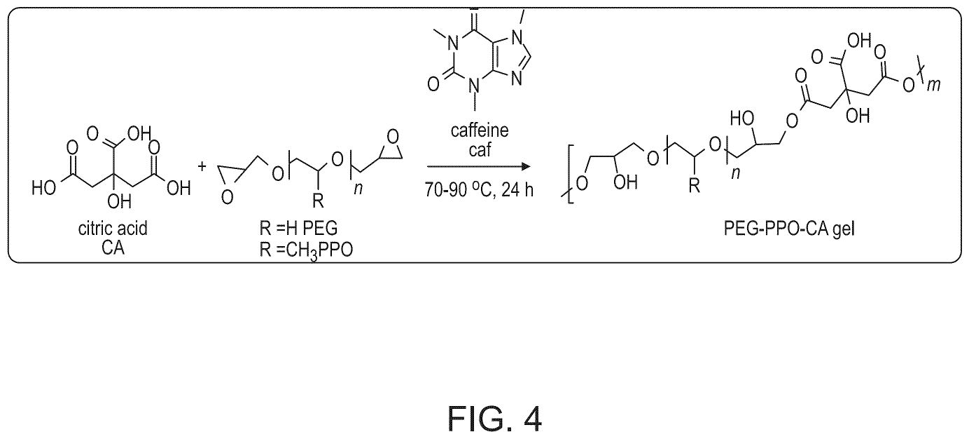

Example 3: In Example 3, a composition of polyethylene, citric acid, the compound with one or more epoxide groups (see FIG. 3 below), and caffeine are extruded to form a non-porous precursor, the non-porous precursor is stretched to form pores, and the citric acid and the compound with one or more epoxide groups are reacted as shown in FIG. 4 to form the PEG-PPO-CA gel product on the right.

Example 4: Example 4 is like Example 3, except that polypropylene was used instead of polyethylene.

Example 5: In Example 5, a dry-stretched porous membrane comprising polypropylene was formed. Next, a solution comprising the reactants shown in FIG. 3 was applied to the membrane. Next, the reactants were reacted.

Example 6: Example 6 is like Example 5 except that the dry-stretched porous membrane comprises polyethylene.

Example 7: In Example 7, a dry-stretched porous membrane comprising polypropylene was formed. Next, a solution comprising the reactants shown in FIG. 4 was applied to the membrane. Next, the reactants were reacted.

Example 8: Example 8 is like Example 7 except that the dry-stretched porous membrane comprises polyethylene.

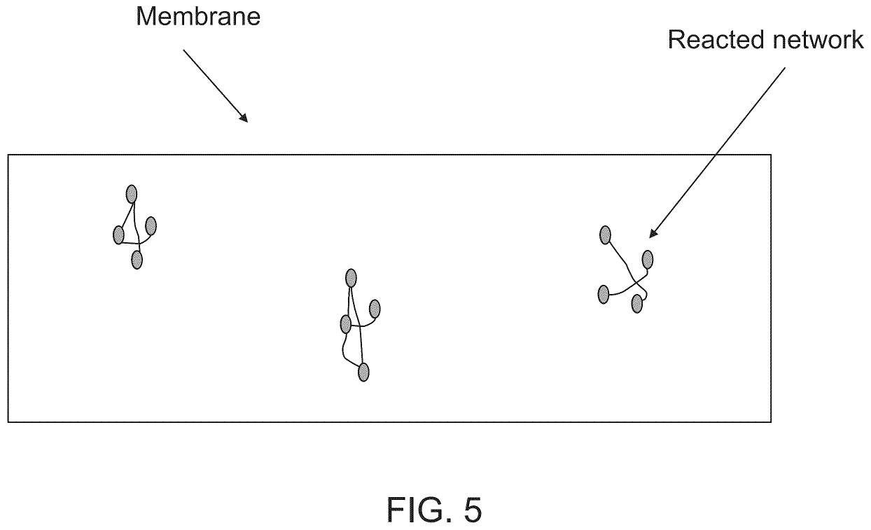

A schematic view of a membrane with reacted networks as disclosed herein may be seen in FIG. 5.

1. A membrane comprising at least one dry-process porous layer that comprises the following:
a polyolefin; and
a product formed by reacting a compound with one or more carboxy groups and a compound with one or more epoxy groups, wherein the product may be a reaction network, a three-dimensional reaction network, or a cross-linked network.

2. The membrane of claim 1, wherein the membrane is a monolayer, bilayer, trilayer, or multilayer membrane.

3. The membrane of claim 1, wherein the compound with one or more epoxy groups has from 1 to 10 epoxy groups.

4. The membrane of claim 1, wherein the compound with one or more epoxy groups has from 1 to 5 epoxy groups.

5. The membrane of claim 1, wherein the compound with one or more epoxy groups is a polyethylene oxide (PEO)/polyethylene glycol (PEG) having two or more epoxy groups.

6. The membrane of claim 1, wherein the compound with one or more carboxy groups has from 1 to 10 carboxy groups.

7. The membrane of claim 1, wherein the compound with one or more carboxy groups has from 1 to 5 carboxy groups.

8. The membrane of claim 1, wherein the polyolefin is a polyethylene polymer, a polyethylene copolymer, a polyethylene terpolymer, or a blend of a polyethylene polymer, copolymer, or terpolymer and another polymer.

9. The membrane of claim 1, wherein the polyolefin is a polypropylene polymer, a polypropylene copolymer, a polypropylene terpolymer, or a blend of a polypropylene polymer, copolymer, or terpolymer and another polymer.

10. A battery separator comprising a membrane according to claim 1 and an optional coating, wherein the coating may be a ceramic coating, a polymer coating, an adhesive coating, a shutdown coating, or combinations thereof.

11. A method for forming a dry-process porous layer, comprising:
extruding or casting a composition comprising a polyolefin, a compound having one or more epoxy groups, an a compound having one or more carboxy groups to form a non-porous precursor;
stretching the non-porous precursor to form pores;
and applying at least enough heat to cause the compound having one or more epoxy groups to react with the compound having one or more carboxy groups to form a product, wherein heat may be applied before stretching, after stretching, during stretching, or any combination thereof, and wherein the product may be a reaction network, a three-dimensional reaction network, or a cross-linked network.

12. The method of claim 11, wherein heat is applied before stretching.

13. The method of claim 11, wherein heat is applied during stretching.

14. The method of claim 11, wherein heat is applied after stretching.

15. The method of claim 11, wherein the heat is applied before and during stretching, before and after stretching, during and after stretching, or before, during, and after stretching.

16. A method comprising:
applying a solution that comprises a compound having one or more carboxy groups, a compound having one or more epoxy groups, and a solvent to a dry-process porous polyolefin film to form an impregnated dry-process porous polyolefin film; and then
applying at least enough heat to the impregnated dry-process porous polyolefin film to cause the compound having one or more epoxy groups to react with the compound having one or more carboxy groups to form a product, wherein the product may be a reaction network, a three-dimensional reaction network, or a cross-linked network.

17. The method of claim 16, wherein the solvent is water, an organic solvent, or a combination of water and an organic solvent.

18. The method of claim 16, wherein a surfactant is added to the solution.

19. The method of claim 16, wherein the dry-process porous polyolefin film comprises a polyethylene polymer, a polyethylene copolymer, a polyethylene terpolymer, or a blend of a polyethylene polymer, copolymer, or terpolymer and another polymer.

20. The method of claim 16, wherein the dry-process porous polyolefin film comprises a polypropylene polymer, a polypropylene copolymer, a polypropylene terpolymer, or a blend of a polypropylene polymer, copolymer, or terpolymer and another polymer.
